(19) United States
(12) Patent Application Publication
(10) Pub. No.: US 2018/0307447 A1
(43) Pub. Date: Oct. 25, 2018

(54) DATA-DEPENDENT LABEL TRANSFORMATION SYSTEM AND METHOD

(71) Applicant: Just One Label, LLC, Chandler, AZ (US)

(72) Inventors: Jeffery William Tufano, Chandler, AZ (US); Raymond Love Simpson, Queen Creek, AZ (US)

(21) Appl. No.: 15/961,551

(22) Filed: Apr. 24, 2018

Related U.S. Application Data
(60) Provisional application No. 62/489,319, filed on Apr. 24, 2017.

(51) Int. Cl. G06F 3/12; G06K 19/06; G06Q 10/08

(52) U.S. Cl. CPC G06F 3/1243; G06F 3/1256; G06F 3/1238; G06Q 10/083; G06K 19/06028; G06K 19/06037; G06F 3/1204

(57) ABSTRACT

In accordance with various example embodiments, a method of generating unique labels within a single print job is disclosed, comprising: receiving a graphical asset object; displaying the graphical asset object; positioning a variable data object relative to the graphical asset object; receiving variable data; and generating a print file. The print file may comprise: a plurality of labels that are all part of a single print job, wherein each label of the plurality of labels includes the graphical asset object; the variable data object located relative to the graphical asset object according to the positioning step; and the variable data. The variable data may be displayed within the variable data object, and each label of the plurality of labels is different from the other labels of the plurality of labels, with each containing unique variable data.

### CROSS-REFERENCE TO RELATED APPLICATIONS

This application claims priority to U.S. Provisional Application No. 62/489,319, filed Apr. 24, 2017, entitled “Systems and Methods for Variable Data Placement and Rendering in Labels,” which is herein incorporated by reference in its entirety for all purposes.

### FIELD

The present disclosure generally relates to organizing, laying out, and printing labels with variable data located on the labels using a website or application.

### BACKGROUND

In the label printing industry, the printing presses typically print a large number of identical labels for a particular product. Even in the context of digital printing presses, it is common to print a large number of identical labels for a single print job associated with a particular product. In some limited cases, a print job may be created with a single label, i.e., one at a time. In that case, a first print job may comprise a first label, and a second print job may comprise a second label that may be different from the first label. However, in this example, each label is in a separate single label print job. In the context of large print jobs, the labels are typically the same when creating a large group of labels.

In other words, typical methods for creating the label and the content of the label do not change for labels for a particular product. The method of creating the label and the content of the label is the same even if there are multiple versions of the same product, there are different components of the same product, the product includes varying features or the product includes a set of identical products that are associated with a different number (e.g., prints of the same painting, limited edition wine bottles, etc.).

There are a number of reasons why it would be desirable to print a large order of labels with some portions of the label being the same and other portions differing one from the other, all in one print job. Thus, new methods and systems of printing labels are desirable.

### SUMMARY

In accordance with various example embodiments, a method of generating unique labels within a single print job is disclosed, comprising: receiving a graphical asset object; displaying the graphical asset object; positioning a variable data object relative to the graphical asset object; receiving variable data; and generating a print file. The print file may comprise: a plurality of labels that are all part of a single print job, wherein each label of the plurality of labels includes the graphical asset object and the variable data. The variable data may be displayed relative to the graphical asset object based on the positioning step. Each label of the plurality of labels is different from the other labels of the plurality of labels, with each containing unique variable data.

In accordance with various example embodiments, a method of generating individual labels from among a plurality of labels in a single print job is disclosed. The individual labels may be at least one of: package-dependent, product-dependent and content-dependent labels. The method may comprise: graphically positioning a variable data object relative to a graphical asset object; generating a print file; and printing the single print job. The print file may comprise a plurality of labels that are all part of a single print job, wherein each label of the plurality of labels in the print job comprises the graphical asset object, wherein each label of the plurality of labels in the print job comprises variable data, wherein the variable data is located relative to the graphical asset object based on the positioning step, and wherein each label of the plurality of labels is different from the other labels of the plurality of labels because of the variable data. Printing the single print job may comprise each label comprising at least one of: package-dependent information, product-dependent information or content-dependent information.

In accordance with various example embodiments, a method of generating a print file for printing a different image for each object of a plurality of objects is disclosed. The method may comprise: graphically positioning a variable data object relative to a graphical asset object; and generating a print file. The print file may comprise a plurality of images that are all part of a single print job, wherein each image in the print file comprises the graphical asset object, wherein each image in the print file comprises variable data, wherein the variable data is located relative to the graphical asset object based on the positioning step, wherein the variable data makes each image in the print file different from the rest of the images of the print file, wherein the variable data is object-dependent information comprising on of: package-dependent information, product-dependent information or content-dependent information. The method may further comprise printing each image from the print file on the corresponding object, on a corresponding package for the object, or on a corresponding label for the object, wherein each image is uniquely associated with only the corresponding object, forming a one-to-one correlation between each object and each image.

### BRIEF DESCRIPTION OF THE DRAWINGS

Additional aspects of the present disclosure will become evident upon reviewing the non-limiting embodiments described in the specification and the claims taken in conjunction with the accompanying figures, wherein like numerals designate like elements, and:

FIG. 1 is an example method of creating a print file with variable data incorporated in the label, in accordance with various embodiments;

FIG. 2 is an example schematic diagram illustrating a system and information flow diagram for printing labels with variable data, in accordance with various embodiments;

FIG. 3 is an example schematic diagram of a system for ordering and printing labels with variable data, in accordance with various embodiments;

FIG. 4 is an example screen shot of entering order information for a print job and adding a graphical asset object, in accordance with various embodiments;

FIG. 5 is an example screen shot of an approved graphical asset object that is missing variable data, in accordance with various embodiments;

FIG. 6 is an example screen shot of how to position the variable data object, in accordance with various embodiments;

FIG. 7 is an example screen shot of adding variable data, in accordance with various embodiments; and

FIG. 8 is an example screen shot of a screen for reviewing the variable data, in accordance with various embodiments.

### DETAILED DESCRIPTION

While exemplary embodiments are described herein in sufficient detail to enable those skilled in the art to practice the disclosure, it should be understood that other embodiments may be realized and that logical changes may be made without departing from the spirit and scope of the disclosure. Thus, the following detailed description is presented for purposes of illustration only.

In various embodiments, a label may be any printable material, which can be affixed to an object, and on which is printed information, graphics, and/or the like. In an example embodiment, a label may be configured to be adhesively attached to a container. In other embodiments, the label may be configured for attaching to a bag, box, bottle, packaging, or directly to merchandize, etc. Any suitable method of attachment may be used.

While the disclosure may include a printed label, one skilled in the art will appreciate that the label (paper, plastic, etc.) portion may not need to exist at all. Instead, a “label” may include the printing being applied directly to the packaging or directly the product or object. In other words, ink would be printed directly onto the packaging and/or product/object. Moreover, the label may include any combination of a printed label and printing onto the packaging and/or product. Stated another way, this disclosure is applicable to printing an image on a product, object, packaging, or label, where the image is part of a print job of images that are unique one from another.

The system may create labels that may be package-dependent, product-dependent and/or content-dependent. For example, the system may create labels that provide information relevant to the labeled item (e.g., container and/or its contents). For example, a label may provide brand information, recommended use information, contents information, contact information, supplemental facts, and/or the like. The label may thus comprise graphics, text, color, etc.

The label may be electronically designed and saved electronically. The electronic representation of the label may be referred to as an image, printable file, an individual graphic, an impression, a 1up, and/or the like. In addition to product type labels (the “primary” label ordered), in accordance with various example embodiments, other labels may be printed including informational labels such as: invoice labels, start labels, shipping labels, address labels, end labels, quantity labels and/or the like.

Although these informational labels may be associated with the primary label ordered, in certain embodiments, a print job may refer only to the primary label, and not to the informational labels associated with the print job. In particular, when reference is made herein to printing unique labels within a print job or labels containing variable data within a print job, this refers to primary labels of that print job that are unique, one from another, and primary labels of that print job that contain variable data.

Traditionally, in the label printing industry, labels have been printed using “ROLL” or “WEB” based printing presses, which typically involve the unwinding of a roll of printable material on the input side of a printing press and the rewinding of the printed material on the output side of the press. Analog printing presses would run the roll past a cylinder that would make labels. Because the cylinder has a fixed image that is transferred to the labels, the labels of that print job would be identical to each other. At best, the cylinder might have a couple different labels on it, for example it might have two different label images on the cylinder. But in this example, the output would be two sets of identical labels from the same print job. There would be no unique information from label to label in the print job.

Somewhat recently, some label print houses have converted to “all digital” printing. These print digital printers do not have to manufacture expensive plates that are wrapped around the cylinders, and each frame can now contain multiple art files. For example, a print house may lay out five print jobs, each print job comprising a different label, and print the five print jobs side by side, each in their own “lane”, running them side by side across the web of the frame. But within each print job, the labels remain identical.

In accordance with an example embodiment, an efficient system and method for printing a print job with unique labels is now described. The method may comprise using, receiving or generating a graphical asset object (e.g., the art work for a label); displaying the graphical asset object; positioning a variable data object (e.g., a placeholder for variable data for a barcode) relative to the graphical asset object; using, receiving or generating variable data; and generating a print file. In this example, the print file comprises a plurality of labels that are all part of a single print job. In this example, each label of the plurality of labels includes: the graphical asset object; the variable data object, located relative to the graphical asset object according to the positioning step; and the variable data. In this example, the variable data is displayed within the variable data object. Thus, each label of the plurality of labels is different from the other labels of the plurality of labels, because each contains unique variable data.

In that regard, the system transforms a label to be an object-dependent, package-dependent, product-dependent and/or content-dependent label, wherein the object, packaging, product or content associated with the product partially or fully impacts how the system creates the variable data that is used for the printing. The movement of the printing head, the amount of ink flow, the frequency of ink flow, where the ink flow starts and stops, and/or the path of the label (or package or product) under the printing head is also package-dependent, product-dependent and/or content-dependent. In other words, the variable data obtained from the content, packaging and/or product may change the physical properties of the printer and have a physical impact on the movement of the printer head and ink flow.

The system may create a label based on variable data such that the label serves as a summary or menu of the variable data that presents information. A subset or all of the variable data can be obtained from the label without needing to open up the package and review the product inside the package. The system goes way beyond manipulating, reorganizing, or collecting data by actually adding a new subset of numbers or characters to the variable data, thereby fundamentally altering the original data to reduce fraud and reduce risks. The system includes a novel combination of steps that operate in a non-conventional and non-generic way to ensure that the contents of the package are verified in a secure manner to reduce fraud that is more than the conventional verification process employed by a regular labeling machine. These steps set up a sequence of events that address unique problems associated with labeling of packages. The system also reduces the need to open a package prematurely just to verify the contents. The system also filters various data about products, packaging and content to determine the most important or suitable data to include in the variable data that is printed on the label. As such, the system takes a prior art generic label printing solution and made it more dynamic and efficient by providing individualized and customized filtering of variable data for the label printer to create labels in a non-conventional way for certain product lines. The system also obtains, displays and/or uses the graphics as part of a very specific, structured graphical user interface and prescribed functionality related to the interface.

The system also creates a label based on variable data such that the label may provide increased safety, reduced health risks, fraud prevention and increased security. The system may scan a product or the packaging and attach the results of that scan (which may include information on important directions, potential problems or warnings associated with the product) to the label by printing the variable data containing such information into the bar code on the label. While some systems may include the same information or warnings on every label, the present system may include warnings in the form of a newly created file based on the particular product, packaging or contents. For example, a gift basket company may have different products in each gift basket. In that regard, the system may print a label for a gift basket that includes variable data related to peanut allergies if that particular gift basket includes peanuts. However, the next basket in the same print job may not include peanuts, but instead includes hand lotion that should not be applied to open wounds, so the system may include variable data that provides such a warning in the label data.

For example, if only 100 of the same wine bottles were filled with wine from the same harvest at a certain time of year, each wine bottle may be numbered as a limited edition. The system may create 100 labels for the wine bottles in the same print job. However, during the same print job, wine bottle #1 may have a label with different variable data than the label for wine bottle #2. In another example, if a company sells 100 different types of posters (movie, sports, scenery, etc.) at different price points and different sizes, the system may create 100 labels for the posters in the same print job. However, during the same print job, poster #1 may have a label with different variable data than the label for poster #2. In that regard, the variable data may change because poster #1 is a small size (package-dependent data) poster (product-dependent data) of a basketball player (content-dependent data).

The system includes specific and limited rules to produce desired results in a process specifically designed to achieve an improved result in a conventional industry practice. The system also greatly speeds the system operation and speeds the creation of labels. In the prior systems, to create labels with different data would require the labeling machine to be stopped, adjusted, new data inputted into the labeling machine, a new package of labels inserted and then re-started. The workers then need to sort different packs of labels and risk putting an incorrect label on a package. In the present system, the use of variable data to continuously run a roll of labels with different information avoids most or all of the prior problems.

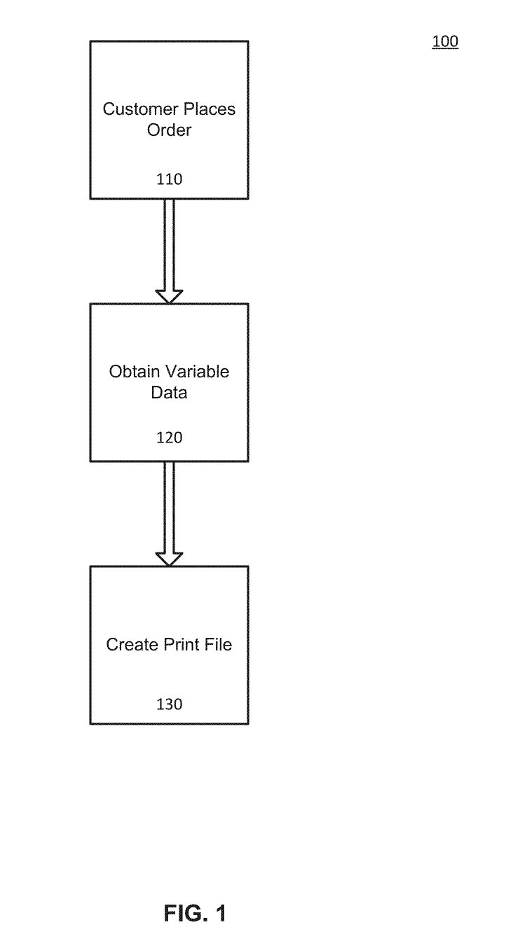

With reference now to FIG. 1, and in accordance with an example embodiment, an efficient system and method for printing a print job with unique labels is now described. A method 100 of generating unique labels within a single print job, can comprise receiving a customer order (step 110), obtaining (e.g., receiving or generating) variable data (step 120), and generating a print file (step 130). Receiving a customer order (step 110) may further comprise obtaining (e.g., receiving or generating) a graphical asset object; displaying the graphical asset object; and positioning a variable data object relative to the graphical asset object.

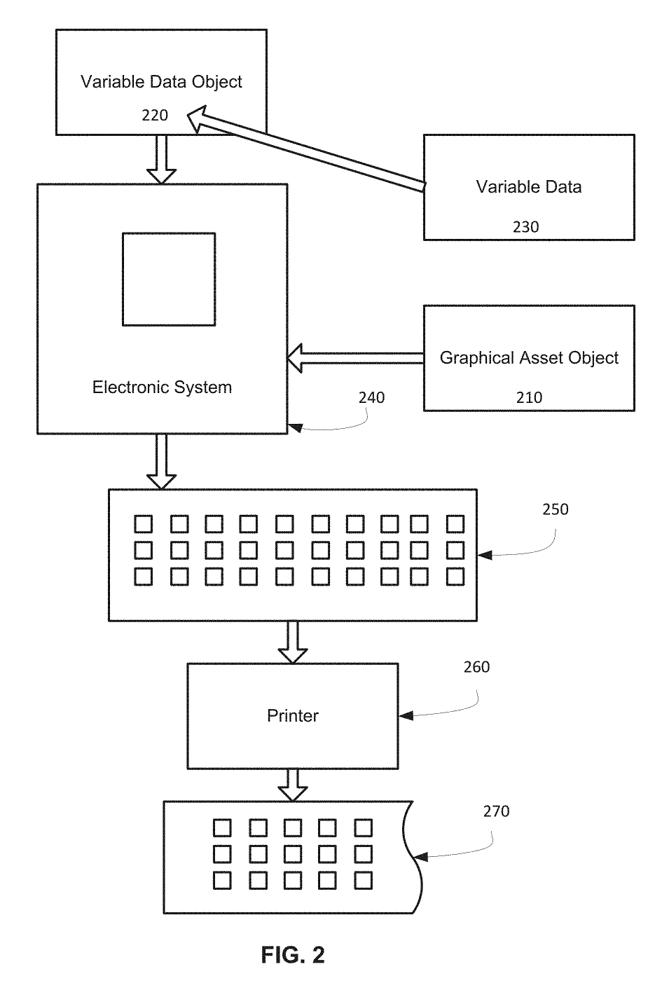

With reference now to FIG. 2, a graphical asset object 210, in an example embodiment, is the artwork for a label. More specifically, graphical asset object 210 is a digital file comprising the artwork for a label. In an example embodiment, graphical asset object 210 is the portion of the labels in the print job that remains constant between the labels. For example, graphical asset object 210 may comprise a label for a nutraceutical, or a label for a product, such as a toy. Graphical asset object 210 may comprise designs, photographs, text, color, and the like. For example, graphical asset object 210 could comprise the ingredients, various marketing slogans, trademarks, and other artwork for the label. These portions of the label may remain constant across each of the labels in a single print job.

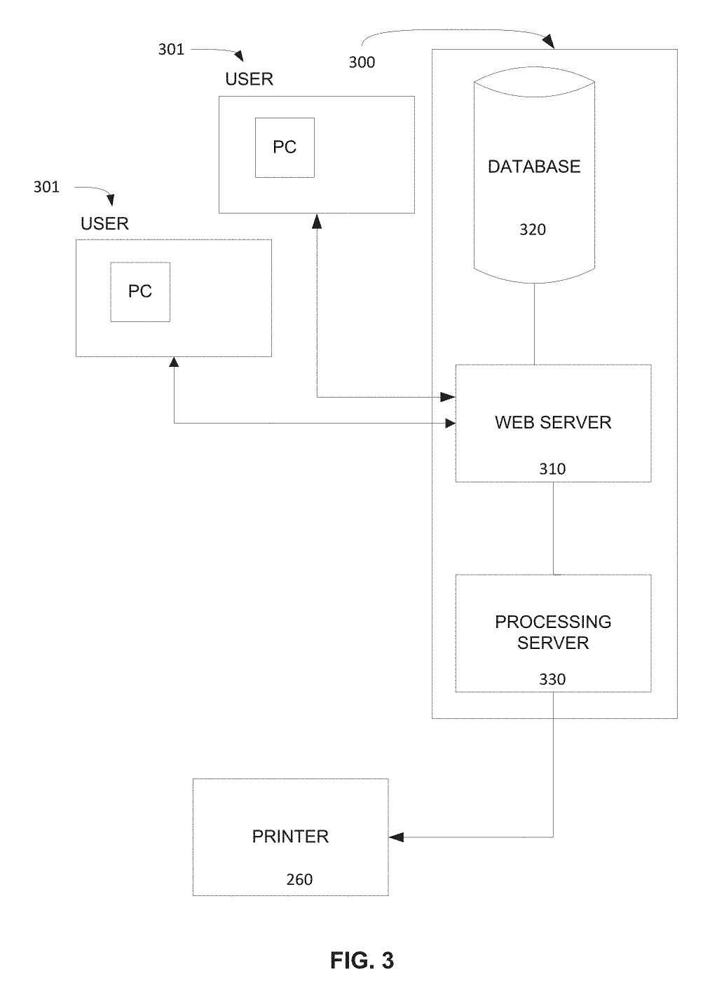

The graphical asset object 210, in an example embodiment, is received from a customer. For example, a customer desiring to have 10,000 nutritional supplement labels printed may prepare artwork for the labels, and save the artwork in a file. In an example embodiment, a customer may transmit the file (the graphical asset object 210) to an electronic system 240. For example, and with reference to FIG. 3, the customer (represented by user 301 (typ.), may use a consumer terminal, such as, a Mac or PC or Linux or any other type of computer, tablet, phone or peripheral with a browser computer with a browser (e.g., a Personal Computer), to visit a website hosted by a webserver 310. Thus, the user may interface, for example, over the internet thru a website located on a web server.

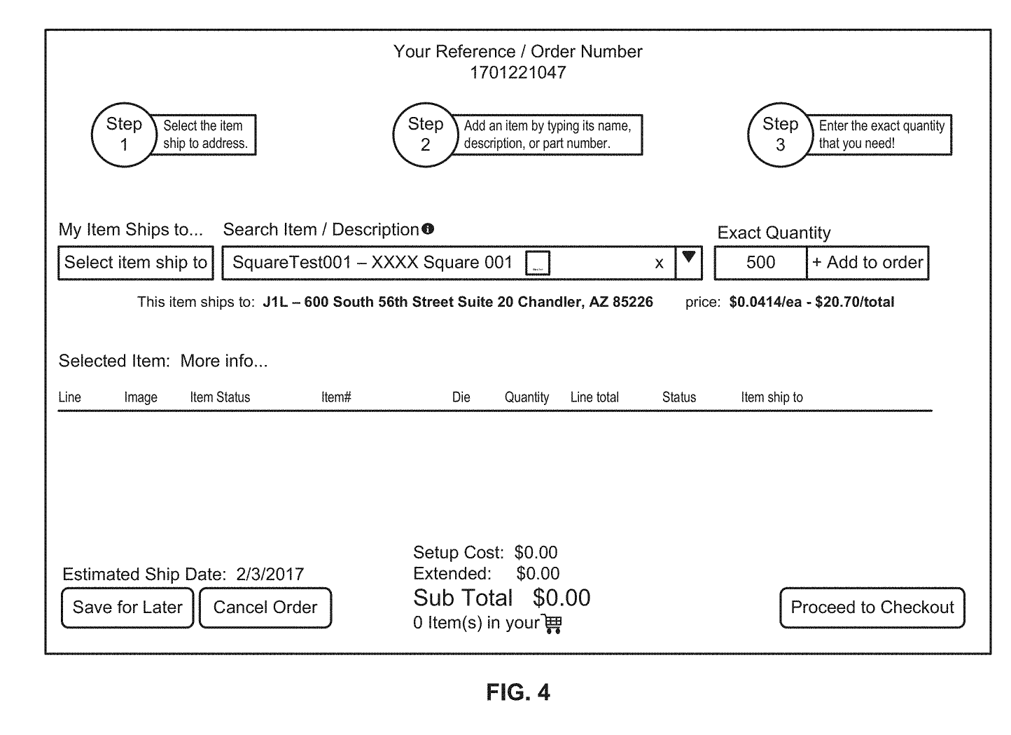

In an example embodiment, a unique label printing system 300 may comprise a webserver 310, a database 320, and a processing server 330. In various example embodiments, the processing server 330 may comprise more than one server, with individual servers providing different or redundant functions. In an example embodiment, the user 301 logs into their account and sees a list of labels they have already created. With reference to FIG. 4, the user 301 may see a screen where they can enter the “ship to address”, select an item to print, and enter the number of that item that they want to print. If the item is not currently listed in the account, the user 301 can select a button requesting to add a new label to their account. The user is taken to a screen for uploading a new graphical asset object. I.e., the user may supply a graphical asset object from an external source. The customer may electronically upload, e-mail, or deliver a graphics file, showing the desired label, in any suitable way to the processing server 330. The customer can also specify the die size, description of the material, finish, dimensions, etc.

In an example embodiment, the graphical asset object 210 may be generated by the electronic system 240 (i.e., internally). For example, the electronic system 240 can generate a graphical asset object based on input characterizing the customer to provide the type of graphical asset object most suitable to that type of customer. In another example embodiment, the electronic system 240 can generate a graphical asset object based on a user selection from among stock options, a menu, or a template. Nevertheless, the user may still be able to make customizations to the graphical asset object. For example, the user may specify or select the size of the graphical asset object, the location of the variable data relative to the graphical asset object, the location and content of text on the graphical asset object, the orientation/rotation of the graphical asset object, the background color of the graphical asset object, the font(s) used in the graphical asset object, and/or the like. For example, the user may select a generic graphical asset object and add text, in a desired font, above and below the location of the variable data object, and rotate the graphical asset object 90 degrees. This option is particularly useful where a user does not have expertise in preparing graphical asset objects, or where a standard options suffice for the job.

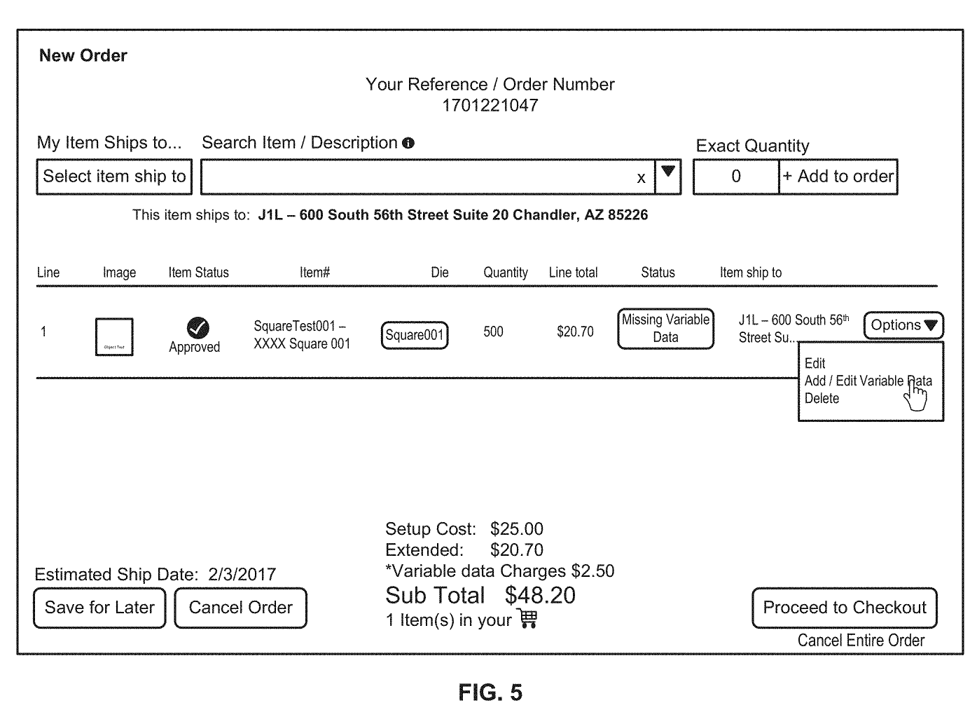

The graphical asset object may be processed by the processing server 330. For example processing server 330 may normalize the graphical asset object 210 by running it thru a template that corresponds to the dimensions selected by the customer. The processed graphical asset object 210 is then passed back to the webserver 310 and displayed to the user 301 on the user's computer device. The user is asked to approve the processed graphical asset object 210. The approved processed graphical asset object 210 is then stored. The graphical asset object 210 file can be stored with a description and all pertinent information by the customer such as dimensions, requested print material, requested finishes, etc. It can be stored locally, in a database 320, in network storage, on the cloud, etc. With reference now to FIG. 5, at this point, the user's may be shown a list of their selected and approved item (label), a thumbnail of their newly added graphical asset object 210, and other information regarding the quantity, die, shipping address, and the like. It is noted, that in FIG. 5, under “status”, it states that the order is ‘missing variable data.’ This variable data may be added, for example by selecting an option to ‘Add/Edit Variable Data.’

As discussed herein, the graphical asset object 210 may have a portion that is reserved for overlaying the variable data. For example, the user uploaded graphical asset object could have been designed with a blank space in the artwork, perhaps having a different color than the rest of the label. However, in other embodiments, the variable data can be superimposed over any portion of the label whether blank or not. Thus, any suitable manner of reserving a position for overlaying the variable data may be used. Moreover, if no space has been ‘reserved’, during the ‘positioning step’ described below, the user can overlay the variable data object as desired as best they can with a graphical art object 210, as is. The positioning may be effectuated throughout he use of a variable data object representing where the variable data will be placed.

In an example embodiment, the user 301 may select an option provided via their web browser to add variable data to the label. In one example embodiment, the user is allowed to select a pre-designed variable data object from a list of pre-designed variable data objects. In another example embodiment, the electronic system 300 is configured to provide the user 301 with a default variable data object. The default variable data object may be selected based on the type, size, or other characteristics of the variable data. In another example embodiment, however, the user is allowed to upload a variable data object 220 of their own creation. In another example embodiment, the electronic system 240 is configured to generate the variable data object 220 automatically. For example, the electronic system 240 can generate a variable data object based on input characterizing the type of variable data object, obtained by prompting the customer to provide input of the type of variable data object most suitable to that type of customer. In another example embodiment, the electronic system 240 can generate a variable data object based on a user selection from among stock options, a menu, or a template. Nevertheless, the user may still be able to make customizations to the variable data object. For example, the user may specify or select the size of the variable data object, the location of the variable data within the variable data object, and/or the like. For example, the user may select a generic variable data object change the size to suit the variable data to be displayed.

In an example embodiment, the variable data object 220 is a digital file comprising size information, and artwork for a generic representation of the variable data. In an example embodiment, the variable data object 220 is a place holder object representing the variable data that will be inserted in the unique labels of the print file and ultimately in the printed unique labels. The variable data object 220, for example, may be a place holder for variable barcode data. In an example embodiment, the variable data object 220 is a graphical representation of a generic barcode. In other example embodiments, the variable data object is a graphical representation of: a 1D bar code, 2D barcode, a barcode place holder object, unique data object, unique symbol object, ordered, sequential data object, non-sequential data object, numeric data object, alpha numeric data object, a serial number, a glyph, or any other variable data. Moreover, the variable data object can further comprise defined trim and safe lines to assist with visual placement of the variable data object. Items on or outside of the safe line will print and should generally be safe, however, due to slight shifts vertically and horizontally during high speed finishing, items on or outside of the safe line may be cut or removed from the finished label.

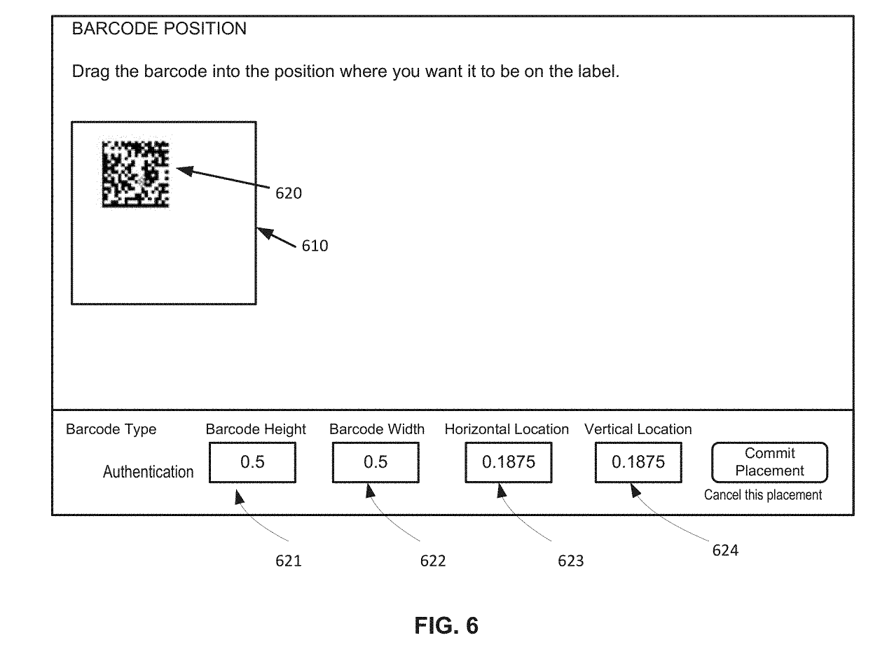

In an example embodiment, the variable data object 220 has a size and a shape. For example, the variable data object 220 can be a rectangle 1″ by 2″, although any suitable dimensions may be used and the shape can be any suitable shape. In an example embodiment, the variable data object 220 is rectangular and has a height and a width. The height and width may be default dimensions, or the user may be permitted to input the height and width. With reference now to FIG. 6, in another example embodiment, the user can enter the height 621 and width 622 of the variable data object 620. In other example embodiments, the user can enter in the size and shape of the variable data object 620.

In an example embodiment, the variable data object is defined (size and shape) by the variable data 230 itself. For example, the size of the variable data object, in an example embodiment, could be defined by amount of data expected inside of the barcode or variable data element. In another example embodiment, the user can scale the size of the variable data object 220. For example, the user may enter a scaling factor, e.g. 50% or 125%, etc., to increase or decrease the dimensions of the variable data object 220. In an example embodiment, the variable data size and shape are not presented as an option, but is preset by the electronic system. The variable data object 220, in one example embodiment, is generated by the electronic system 240.

In another example embodiment, the variable data object 220 is created by the customer. In this example embodiment, the variable data object 220 is received by the electronic system 240 when the customer uploads it to the electronic system 240. In another example embodiment, the variable data object 220 is defined by a third party that provides the variable data. For example, the variable data object 220 may be provided by a provider of unique bar codes, unique 2D data matrices, or unique UPC's, or provided by an online merchant, or the like. In an example embodiment, the variable data object is provided by the electronic system 240, itself.

In an example embodiment, graphical asset object 210 is designed to have a portion that is suitable for, or reserved for overlay of the variable data object 220. As mentioned above, in other embodiments, no portion was reserved, but the variable data object 220 is positioned as best possible, anyway. In an example embodiment, the variable data object 220 is positioned relative to the graphical asset object 210. Positioning the variable data object 220 relative to the graphical asset object 210 may be accomplished (1) in an automated way, (2) by entry of positioning dimensions by the user, or (3) by graphically dragging and dropping one relative to the other. For example, the system 240 may be configured to position the variable data object 220 relative to the graphical asset object 210 in an automated manner by recognizing the location on the graphical asset object 210 (such as where the graphical asset object bears an indicator of where the variable data should appear) reserved for the variable data object, and positioning the variable data object 220 to fit in that space.

However, in another example embodiment, the user 301 can enter coordinate information (e.g., a horizontal location 623 and a vertical location 624), and the electronic system can receive the coordinate information for positioning the variable data object 620. In another example embodiment, positioning the variable data object is done by dragging a graphical representation of the variable data object 620 (the barcode placeholder) displayed relative to graphic art object 610 (the label artwork) into the position desired relative to the graphic asset object 620. Thus, positioning the variable data object 620 may further comprise graphically positioning the variable data object relative to the graphical asset object 610. Thus, the electronic system can be configured to locate, place, or position the variable data object 620 relative to the graphical asset object 610 in a suitable location. Furthermore, the method may comprise any suitable method of locating variable data object 620 relative to graphical asset object 210. User 301 may commit to the placement of the variable data object 620, by selecting “commit placement.” It is noted, that any suitable method of locating the variable data object 620 relative to the graphical asset object 210 may be used.

System 300 may be configured to display a rendered image showing the positioning of graphical asset object 210 relative to variable data object 220. This may be shown with trim lines and/or safe lines displaying defined trim and safe lines superimposed on top of the label, e.g. represented by different colors, or any suitable visual representation of where the artwork will be trimmed. The user 301 can confirm the user's acceptance of the combined label information. The coordinate information for positioning the variable data object can be stored. The system can be configured to receive an approval of the displayed rendered image. This has the advantage of the user being able to conduct the entire process of entering the label, positioning random data, and adding the random data to generate the print file without intervention of print house operators.

In an example embodiment, the system may be configured to facilitate approval teams. For example, the system may be configured to receive input identifying two or more approvers. The approvers may be individuals or entities, and may be from the same company or from separate entities collaborating on the label creation. The approvers may all have access to a single account, or may have their own accounts with permission to work collaboratively on one or more projects on another user's account. In an example embodiment, one or both approvers can change the inputs in the process described herein. The collaborative users/approvers can edit each other's work, make changes, or suggest changes. In an example embodiment, all approvers have to approve the rendered image before the printing process commences. For example, a manufacturer and a distributor may each have an employee collaborating on the co-branded label for a product made by the manufacturer and to be distributed by the distributor. One of the two employees may upload the graphical asset object and make all of the inputs, then the other employee may modify the text on the label and the fonts to reflect desired changes. Once both employee's approve the rendered image, the file may be sent to print the labels.

In an example embodiment, and with reference again to FIGS. 1 and 2, the method 100 further comprises obtaining variable data 230 (step 120). In an example embodiment, the variable data 230 represents barcode type information. In another example embodiment, the variable data is any unique data, such that each variable data is different from another variable data. The variable data can be any data (numbers, letters or symbols) associated with a graphical object in some manner. In an example embodiment, the variable data is ordered. In another example embodiment, the variable data is sequential. In an example embodiment, the variable data is numeric or alpha numeric. Thus, in an example embodiment, the variable data is at least one of: ordered, sequential, non-sequential, numeric, alpha-numeric, or symbol. For example, the variable data may be UPC data, 2D matrix data, variable bar code data, and/or any suitable variable data.

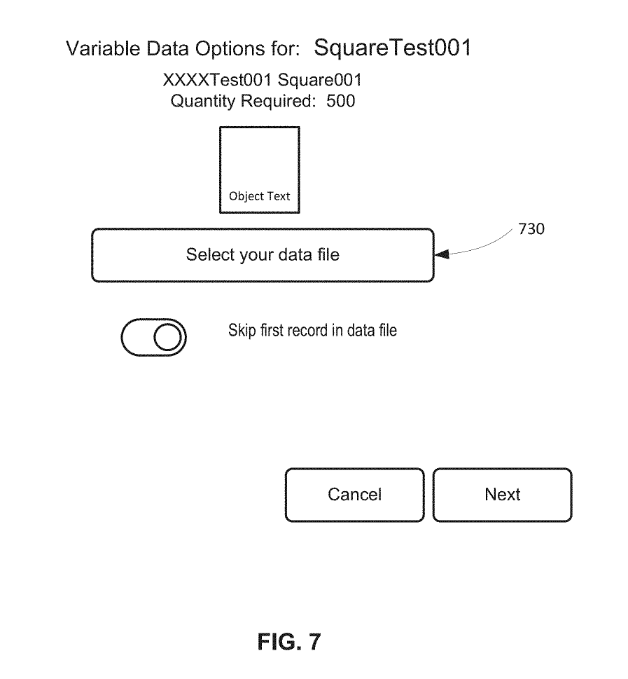

In an example embodiment, variable data can be added. For example, and with reference to FIG. 7, a user can request variable data be added by selecting “select your data file” 730. This request can trigger receiving variable data 230 from a source of variable data. In one example embodiment, the variable data 230 is generated by a variable data generator. In an example embodiment, the variable data 230 can be provided by a third party, such as a third party supplier of unique bar codes. In an example embodiment, the variable data is added in an automated manner.

In an example embodiment, the variable data 230 is created by the customer. In this example embodiment, the variable data 230 is received by the electronic system 240 when the customer uploads it to the electronic system 240. In another example embodiment, the variable data 230 is defined by a third party that provides the variable data. For example, the variable data 230 may be provided by a provider of unique bar codes, an online merchant, or the like. In an example embodiment, the variable data 230 is provided by the electronic system 240, itself.

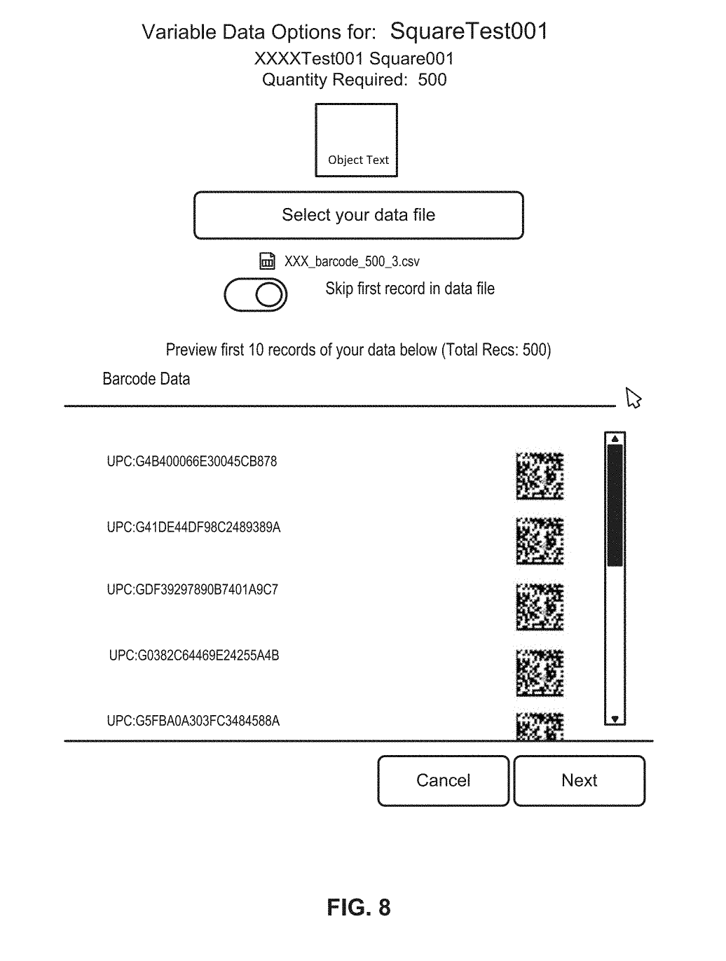

In an example embodiment, the system 300 is configured to test whether there is any data violation in the variable data 230 that is provided to system 300. For example, the variable data could be subjected to a security check or authentication procedure. The security check could determine if the variable data 230 has ever before been provided to another party. The security check could determine if the variable data 230 has ever before been printed in another label. The security check could determine if the variable data 230 is unique as between each data provided for the particular print job. With momentary reference to FIG. 8, the user may be presented a list, or partial list, of the variable data to visually confirm the variable data is appropriate for adding to the print job.

In this way the variable data can be different data for each label in a print job. As a specific example, each label in a print job can have a different bar code. In an example embodiment, the checking process further prohibits fraud or accidental printing of duplicate labels. This can help with assessment of whether black market goods are being sold, or conversely whether the goods being sold are authentic. If the data passes this check, the system 300 can create an individual file, or 1up, for each label. Each individual file can comprise a graphical asset object and associated information about the location of the variable object data, and the variable data. The individual file could further comprise human readable text or information.

In accordance with an example embodiment, and with reference again to FIGS. 1 and 2, the method 100 further comprises creating a print file 250 (step 130). In an example embodiment, the electronic system is configured to create a print file by generating a pdf (or any other press or print compatible file) by populating a frame with each label of the print job. The display of each label may be based on the information in each individual file.

In this example, the print file comprises a plurality of labels that are all part of a single print job, wherein each label of the plurality of labels includes the graphical asset object, the variable data object located relative to the graphical asset object according to the positioning step, and the variable data. In an example embodiment, variable data is displayed or located within the variable data object. That is to say, the variable data is displayed or located in the location specified for the variable data object. Thus, in each label in the print file, unique variable data is displayed or located, overlaid with the graphical art object. In this manner, each print file label of the plurality of labels is different from the other print file labels of the plurality of labels. Each has the commonality of the graphical art object, but each is overlaid with unique variable data.

In an example embodiment, the file can then be exported from this process into a standard file format that can be understood by whatever format is needed by the printing press 260 (this may include PDF, Illustrator, Photoshop, or any other format that may be used by the printing press). The printing can be roll based or lane based.

At any suitable point in the process, the user can place an order for a plurality of labels that have the same artwork with the exception of the variable data (a print job). The customer can place the order over the phone with an employee who may enter the order electronically. Alternatively, the customer can order the labels via an electronic interface, e.g., the browser. Thus, in accordance with this disclosure, it is possible for a user to effectuate the process autonomously, without intervention of a graphic artist or other human working for the printer. This greatly reduces the time and cost to create a print file and ultimately to order and receive labels. Not only can a user generate unique labels in a single print job, but the entire process can be operated by the user.

The print file can be moved to the print server where it can be converted into a format that the press can use to print. The press operator can then print the print job(s) as one print run and deliver the print in a roll to the finishing process. Thus, in an example embodiment, the press creates an output of printed labels 270, with each label unique from the other labels, varying from each other by the variable data provided thereon, and partially similar to each other by the common graphical art object on which the variable data is overlaid. The entire print job(s) can then be cut and sliced into individual lanes on individual rolls that contain the unique labels of the print job(s). These rolls can then be brought to a machine that can separate each of these print jobs onto individual rolls into the original individual requested quantities. In an example embodiment, a quality check can be made to ensure that there are no defects. The rolls of labels can be separated, packaged, and shipped to the individual customers. The customer can then be, in an example embodiment, invoiced and the individual line on that order for that customer is closed.

In some example embodiments (e.g., Indigo press), the server provides a text file to the press, which uses its internal programming to process the text file to print a single frame, and then provides the next text file to the press to print the next frame. Thus, by providing sequential text files, the printer can be forced to print the lanes as laid out with jobs end to end/wrapped as described herein. In another example embodiment, the entire layout is created using any suitable web publishing software (MS Word, etc.) and the entire layout is sent to the press. In the former, the printer uses the text file and 1ups to properly locate the 1ups. In the latter, the printer merely prints the entire master frame.

Although described above with very specific quantities of labels and numbers of different label types, the principles may be applied more generally. Although described in various portions of this disclosure in terms of “printing labels,” it is noted that the principles discussed herein are equally applicable to other print jobs. For example, the same techniques may be used for printing tickets, conference badges, decals, coupons, shipping documents, stamps, seals, price tags, or anything else that can be printed and delivered in a roll format. Stated generically, the print job may comprise a graphic that is printed multiple times to form individual printed items with a portion of the individual printed items that is unique or has unique data. The unique graphic may be referred to as a single printable file, a graphic, an impression, an image, or a 1up. The unique graphic may comprise text, artwork, logos, information, raster art, and/or the like. A 1up may be defined as one unique art or graphic file that consists of one or many colors and contains line art, vector art, raster art, images, and/or text. Therefore, throughout the disclosure the references to labels should be read broadly to include reference to any type of printed item (label or otherwise) within print jobs that are suitable for lane based roll type printing as described herein, where the labels are unique from one another.

In an example embodiment, the printing is commercial printing. In another example embodiment, the printing is roll based or web based printing. In an example embodiment, the label printing of the present disclosure is not used in non-roll based printing. In an example embodiment, the label printing of the present disclosure is not used in printing single sheets of labels or business cards. In an example embodiment, the printing is lane-based printing. The lane-based printing comprises printing individual graphics on a roll of printable material.

In one example embodiment, the printing is label printing. In accordance with an example embodiment, the printing is digital printing. In one example embodiment, the digital printing may comprise a cylinder, wherein the laser writes an image to the cylinder to create a temporary image on the cylinder, which picks up color and transfers the color to the printable material. In another example embodiment, the digital printing does not involve physical cylinders. Rather, the label printing is printed digitally using one or more toner cartridges or stations, or one or more ink cartridges or stations. In these example embodiments, the digital toner or inkjet like stations may lay the color down on the printable material one color at a time or as one single shot. For example, the label printing system may comprise a digital cylinder type printer such as the Indigo™ printer provided by HP', or a toner or inkjet type printer such as are provided by Xeikon™, Xerox, Canon™, or any other digital printing press. Moreover, the press may be configured to work with the Cyan, Magenta, Yellow, Black (“CMYK”) colors, or any other suitable number of colors, e.g., 5 colors, 6 colors, and fewer or greater numbers of colors.

In one example embodiment, the printing can be laid out with reference to a frame. Other example embodiments that do not involve a frame will be described herein as well. This frame convention is most appropriate in digital cylinder printing where the frame may have a size determined by the size of the cylinder. Moreover, whether the digital printing involves a cylinder or no, it should be understood that in example embodiments, the frame herein may have a size that is not related to the size of the cylinder.

In these example embodiments, the printing comprises one or more lanes across a frame/drum or width of the printable material. The lane-based printing may further comprise printing individual images (e.g., labels) in a lane where the lane crosses more than one frame. In an example embodiment, the lanes of labels are separated one lane from another, spliced end to end, and rolled to form a roll of labels (i.e., in a single line of labels).

For clarity, when discussing a frame herein, the frame comprises a width and a length. The width is the dimension of the frame that corresponds to the width of the printable material (across the roll). The width of the frame may also correspond to the direction/distance across the drum of the cylinder, if one is used. In an example embodiment, the frame width is 11.625 inches. Moreover, the frame width may be from 1 inch to 30 inches, and more preferably from 10 inches to 30 inches. Moreover, the frame width may be any suitable width.

The length of the frame is the dimension of the frame in the direction of the printable material as it comes off the roll to be fed into the printer. Though this length may be related to the distance around the cylinder, it may alternatively be set to be any suitable length. In an example embodiment, the frame length is approximately 17 inches. Moreover, the frame length may be from 3 inches to 44 inches, and more preferably from 4 inches to 44 inches. Moreover, the frame length may be any suitable length.

In an example embodiment, a frame may comprise an array of 1up's. The frame may comprise more than one row (or lane) of 1up's. The frame may also comprise at least one column of labels laid out along or in parallel with a Y axis perpendicular to an X axis. Here, the X axis is in the length direction as the roll of printable material is unrolled, and the Y axis is in the direction across the width of the roll. This width is the width of the printable material itself and doesn't change as the roll is unwound. In one example embodiment, a lane is a row of 1up's laid-out along or in parallel with the X axis. In another example embodiment, a frame comprises a two dimensional array of labels with more than one row and more than one column of individual graphics (e.g., labels). Each row may comprise part of a lane of labels. Thus, each row or lane may be oriented parallel with the length of the frame. Each column may be oriented parallel with the width of the frame.

As stated above, in various example embodiments, the printing may be for use in connection with roll based printing involving more than one frame, wherein the lanes cross over more than one frame. In an example embodiment, the printing is not used in single frame printing, meaning that the print job is not accomplished using a single frame of individual graphics that is repetitively printed to fulfill the entire print job. In an example embodiment, the frames comprise a plurality of consecutive frames that comprise a total number of frames greater than one. The plurality of consecutive frames may comprise W frames (where W is greater than one).

In another embodiment, the frame is larger or smaller than it would be for a cylinder. For example, the frame could be approximately the width of the roll of printable material and the length could be determined to be long enough to accommodate lane based printing of an entire gang of print jobs. In this embodiment, the total number of graphic items to be printed across the entire gang of print jobs can be divided by the number of lanes across the width of the roll of printable material. This result gives the number of graphic items to be printed in each lane. From this, and with any appropriate spacing between the graphic items to be printed, the length of the frame can be calculated. Thus, a single frame, or super frame, could accommodate the entire gang of print jobs.

As mentioned above, it is also possible to implement the system and method of printing disclosed herein without use of a frame. Accordingly, in an example embodiment, the system may determine how many columns and rows of 1ups to use (where, for example, a first print job has a first number of times to print that 1up (with variable data), and a second print job has a second number of times to print a different 1up (with its variable data), where each 1up includes a portion of the variable data making it different, partially, from the other 1ups.

The system lays out printing of copies of the first 1up (but with variable data in each 1up) starting in a first lane printing the 1up of a first job and then continuing laying out the 1up of the second job after laying out the first number of the 1up of the first job. If the end of the lane (i.e., the last column in a particular row) is reached and there are still more of the 1up of that job to layout, the linear laying out of the 1up of that particular print job is configured to continue in a different lane. This can continue, for example, until each print job has been laid out, one after the other, wrapping around to different lanes across the web of the printable material and along the length of the printable material just as far as needed to accommodate all of the 1up's desired to be printed.

In accordance with an example embodiment, the system and method may comprise identifying a first label print job and a second label print job. The first label print job differs from the second label print job. The difference between the first and second label print jobs may be due to at least one of the following differences: different customers, different purchase orders, different line numbers, different label graphics, different label text, different line art, and/or any other difference between files or graphics, other than the variable data.

In accordance with an example embodiment, the number of labels in the first print job may be different from the number of labels in the second print job. In some example embodiments, the number of labels in one print job is different from the number of labels in at least one of the other print jobs. In yet another example embodiment, the number of labels in each print job is the same, for all print jobs in the gang of print jobs, and the number of print jobs is more or less than the number of lanes. In this last example embodiment, even with the same number of printed individual graphics (e.g., labels) in each print job, the difference between the number of print jobs and the number of lanes will result in print jobs wrapping into additional lanes. More generally, in example embodiments, at least one of the print jobs, in a gang of print jobs, is laid out and subsequently printed in less than or more than one lane. The print jobs are also laid out and subsequently printed “end to end.” This means that they are laid out and subsequently printed in a manner to facilitate creating a roll of labels by slicing the lanes apart and splicing the end of one lane to the end of another lane. In this embodiment, all of the labels of a first job are lined up together. On the same roll, or a different roll, all of the labels of a second job are lined up together (if on the same roll, they are lined up before or after the labels of the first job).

Moreover, in an example embodiment, informational labels may be associated with a print job, located before a print job, located between print jobs, or located after a print job. These informational labels may comprise any label other than the primary label ordered. For example, informational labels may comprise an invoice label, a start label, a shipping label, a quantity label, an end label, and the like. The quantity label may identify the number of labels in the print job. In an example embodiment, the number of labels in a first print job may be X and the number of labels in a second print job may be Y, and X may be different than Y. In an example embodiment, the informational label may further comprise at least one of: retention labels, coupon labels, job description labels, return merchandize authorization labels, receiving information labels, reseller or distributer branding labels, print cleaning graphic or an image to remove ghosting, registration marks, color bars or any other descriptor label that may be beneficial to the business or customer.

The method of printing labels may further comprise printing informational labels between the first label print job and second label print job. In this example embodiment, the informational label may be considered an “intermediate label” or “intermediate indicator.” Moreover, in one example embodiment, the informational labels may be considered to be associated with an individual print job. In another example embodiment, the informational labels may be considered to be outside of and appended to the individual print jobs.

In an example embodiment, a method of printing labels, wherein the labels comprise first and second print jobs, further comprises forming a gang of label print jobs comprising the first and second label print jobs. Thus, a gang of label print jobs may comprise two label print jobs, three label print jobs, up to any suitable number of label print jobs.

Stated another way, in an example embodiment, the method comprises qualifying a print job. In this example embodiment, qualifying the job further comprises grouping jobs together that involve similar features to form a gang of label print jobs. For example, the similar features may comprise one of: similar material types, material thickness, material quality, material finish, material laminate, varnishes, embossing, foil stamping, debossing, number of colors, and similar finished dimensions.

The method of printing labels may be used, for example, on labels or any print job that is printed using digital lane-based printing on printing material that is roll fed into the printing machine. The printing material in one example embodiment, is a 60# semi-gloss paper, estate paper, kraft paper, recycled paper, card stock, vellum, metalized paper or silver foil, holographic paper, cloth, tag material, clear polypropylene, metalized polypropylene, white polypropylene, vinyl, polyester, magnetic stock, or other printable materials. Furthermore, any suitable printing material may be used. Moreover, the labels or items being printed may have a size of about 1.875″ by 4.5.″ In other example embodiments the labels may be from 0.125 to 30 inches by from 0.125 to 44″ inches. Furthermore, in another example embodiment the labels may be as wide as the printable material width divided by two and as long as the total roll length divided by two. Moreover, the labels may be of any suitable size that still allows at least two lanes of labels to be printed in a single frame, or across the width of the printable material. However, the labels can be printed in a single lane, as well. In an example embodiment, the labels are approximately rectangular in shape. In other example embodiments, the labels are square, oval, circular, triangular, or any odd shape. Moreover, the label can be any suitable shape.

In an example embodiment, the method further comprises organizing the printing of the gang of print jobs across a plurality of consecutive frames, wherein the frames comprise at least two lanes, and wherein each lane runs across all of the plurality of consecutive frames. In one example embodiment, the method of printing labels thus comprises aggregated, lane-based, digital label printing. The printing is said to be aggregated because more than one print job is aggregated to form a gang of print jobs that is printed at the same time as the other print jobs in the gang of print jobs. However, in other example embodiments, a single print job can be printed at a time.

Stated another way, in one example embodiment, the method may comprise laying out labels from the first label print job successively within a lane of said at least two lanes and starting in a first lane of the at least two lanes, wherein the laying out of labels from the first label print job continues in a second lane of the at least two lanes if: (a) the first lane is full, and (b) all labels from the first print job have not yet been laid out. The method may further comprise laying out labels from the second label print job successively within a lane of said at least two lanes and starting following the first label print job.

Although described herein as wrapping around to the next closest lane, it should be understood that the sequential layout of labels may wrap around to any of the remaining lanes, as desired.

It is noted that the discussion herein is relevant to how the individual and partially unique graphics within two or more print jobs are laid out and, after the gang of print jobs have been printed, the pattern of those individual graphics in the printed product. Nevertheless, the actual process of printing occurs as the printable material passes under the cylinder, ink jet print heads or drum. Thus, two or more labels in a column are printed at the same time. The labels may be from the same job or a different job, according to the predetermined layout of the print jobs. Thus, standard printing equipment can physically print using the same physical printer as before, but with vastly different, useful and efficient results by predetermining a layout of individual graphics to be printed in gangs of print jobs and driving the printing equipment according to that predetermined layout.

In accordance with various embodiments, the method further comprises slicing the first lane apart from the second lane across multiple frames. The method may further comprise splicing the first lane onto the end of the second lane, and rolling up the spliced labels to form a roll of labels that is a gang of labels all in a single row with the first label job coming off the roll of labels before the second label job comes off, or vice versa.

Modern printing presses use many methods of printing. Digital printing presses, for example, may use one or more cylinders with each cylinder representing a color, one or more toner cartridges with each cartridge representing a color, one or more ink cartridges with each ink cartridge representing a color or any other method of applying one or more colors to the printable material. These presses may apply the colors to the printable material at one time or one color at a time. For example, most print jobs run as four color or “PROCESS COLOR” print jobs using “CMYK” (Cyan, Magenta, Yellow, and Black) colors. Each cylinder, traditionally is wrapped with a “plate” that represents a single color of the art work. These plates, when merged and unwrapped represent a single frame. The frame dimension is usually decided based on the most number of labels that can fit on the cylinder.

Analog printing presses used plates or cylinders to make the impressions on the labels. With the advent of digital printing these plates or cylinders can take different forms. For example some digital presses use a laser to write an image to a cylinder and that cylinder creates a temporary image that picks up one to many colors and transfers them onto the printed material. Other examples are similar to a photo copier or a laser printer or an inkjet printer, and in these examples the material (as it passes by the writing heads) receives the individual colors as toner, or ink, or any similar method of transferring individual colors to the material.

In one example, a cylinder may be configured, i.e., wrapped, with a “plate” that prints one frame of labels. The length of the cylinder is known as the “web,” or “across the web.” Thus, the width of the frame may be about the same as the web or length of the cylinder. The direction around the cylinder is known as “with the web.” Thus, the length of the frame may be about the same length as the circumference around cylinder.

By way of example, a label may be 1.875 inches high and 4.5 inches wide, and a frame may have a width of 11.625 inches and a length of 17 inches. Accounting for space between the labels, in this example, the maximum labels across the width may be five and the maximum labels along the length of the frame may be three. Though any suitable label dimensions may be used and any suitable number of labels may be provided in a frame.

The present disclosure may be described herein in terms of functional block components, screen shots, optional selections, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as C, C++, Java, .Net, JavaScript, or the like, with the various algorithms being implemented with any combination of data structures, objects, processes, routines or other programming elements. Further, it should be noted that the present disclosure may employ any number of conventional techniques for data transmission, signaling, data processing, network control, and the like.

It should be appreciated that the particular implementations shown and described herein are illustrative of the disclosure and its best mode and are not intended to otherwise limit the scope of the present disclosure in any way. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

It will be appreciated that many applications of the present disclosure could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), tablet, cellular phone, smart phone, and/or the like. Similarly, the disclosure could be used in conjunction with any type of personal computer, network computer, workstation, minicomputer, mainframe, or the like running any operating system such as any version of, DOS, Windows, Windows NT, Windows 2000, Windows 98, Windows 95, Windows 7, Windows 8, Windows 10, MacOS, OS/2, BeOS, Linux, UNIX, or the like. Moreover, although the disclosure may be implemented with TCP/IP communications protocols, it will be readily understood that the disclosure could also be implemented using IPX, Appletalk, IP-6, NetBIOS, OSI, or any number of existing or future protocols.

The system may have a computing unit implemented in the form of a computer-server, although other implementations are possible, such as a main frame computer. However, the system may be implemented in other forms, such as a mini-computer, a PC server, a network set of computers, and/or the like.

In an exemplary implementation, the system is implemented as computer software modules loaded onto the system computer or in a cloud environment or off site server.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present disclosure is described herein with reference to block diagrams and flowchart illustrations of methods, apparatus (e.g., systems), and computer program products according to various aspects of the disclosure. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the steps recited in any method claims may be executed in any order and are not limited to the order presented in the claims. Moreover, no element is essential to the practice of the disclosure unless specifically described herein as “critical” or “essential.”

What is claimed is:

1. A method of generating unique labels within a single print job, the method comprising:
receiving a graphical asset object;
displaying the graphical asset object;
positioning a variable data object relative to the graphical asset object;
receiving variable data;
generating a print file, the print file comprising a plurality of labels that are all part of a single print job, wherein each label of the plurality of labels includes the graphical asset object, and the variable data, wherein the variable data is displayed relative to the graphical asset object based on the positioning step, and wherein each label of the plurality of labels is different from the other labels of the plurality of labels, with each containing unique variable data.

2. The method of claim 1 further comprising:
delivering the print file to a printer; and
printing, at the printer, a plurality of physical labels from the print file, where each physical label of the plurality of physical labels is different from the other physical labels by the variable data.

3. The method of claim 1 further comprising: creating a data file comprising: information configured to facilitate printing of labels, where each label contains the variable data, the information comprising: the graphical asset object, the variable data object, and the variable data.

4. The method of claim 1 further comprising:
displaying a rendered image combining the graphical asset object and the variable data object; and
receiving an approval of the displayed rendered image, wherein the positioning the variable data object further comprises graphically positioning the variable data object relative to the graphical asset object.

5. The method of claim 1, wherein the graphical asset object comprises artwork for a label, wherein the artwork for the label is received from a customer, wherein the graphical asset object has a location reserved for the variable data object to be located.

6. The method of claim 1, wherein the variable data object is a graphical representation of a generic barcode.

7. The method of claim 1, wherein the variable data object comprises at least one of: a 1D bar code, 2D barcode, a serial number, a barcode place holder object, unique data object, unique symbol object, ordered, sequential data object, non-sequential data object, numeric data object, alpha numeric data object.

8. The method of claim 1, wherein at least one of:
receiving the graphical asset object comprises at least one of: receiving the graphical asset object from a user, or generating the graphical asset object internally; and
receiving variable data comprises at least one of: receiving variable data from an external source, or generating the variable data internally.

9. The method of claim 1, wherein positioning the variable data object further comprises:
receiving dimensions of the variable data object, by:
receiving a height of the variable data object; and
receiving a width of the variable data object.

10. The method of claim 9, wherein positioning the variable data object further comprises receiving coordinate information for positioning the variable data object.

11. The method of claim 1, wherein positioning the variable data object further comprises: dragging a graphical representation of a barcode into a desired position on the label.

12. The method of claim 1, wherein the variable data is at least one of: sequential, non-sequential, numeric, alpha-numeric, or symbol.

13. The method of claim 1, further comprising: creating a second print file with different variable data, without receiving the graphical asset object, without receiving a variable data object, and without positioning the variable data object relative to the graphical asset object.

14. The method of claim 1, further comprising authentication of the labels of the single print job by performing a security check to ensure that each individual label in the print file has never been generated before.

15. A method of printing labels in lane based printing where labels from a first print job comprise unique data such that each label varies from the other labels of the first print job, wherein the difference is in the variable data overlaid on each label.

16. The method of claim 15, further comprising authentication of the variable data to ensure that the unique data has not been printed on any other labels to prevent fraud.

17. A method of generating individual labels from among a plurality of labels in a single print job, wherein the individual labels are at least one of: package-dependent, product-dependent and content-dependent labels, the method comprising:
graphically positioning a variable data object relative to a graphical asset object;
generating a print file, the print file comprising the plurality of labels that are all part of a single print job, wherein each label of the plurality of labels in the print file comprises the graphical asset object, wherein each label of the plurality of labels in the print file comprises variable data, wherein the variable data is located relative to the graphical asset object based on the positioning step, and wherein each label of the plurality of labels is different from the other labels of the plurality of labels because of the variable data;
printing the single print job to generate the plurality of labels with each label comprising at least one of: package-dependent information, product-dependent information or content-dependent information.

18. The method of claim 17, further comprising accessing a variable data file comprising the variable data.

19. The method of claim 17, further comprising attaching each label of the print file to an object corresponding to the label such that any of the package-dependent information, product-dependent information and content-dependent information on the label is uniquely associated with the object forming a one-to-one correlation between the object and the label, wherein no two objects are labeled with an identical label and no two identical labels are attached to any objects.

20. A method of generating a print file for printing a different image for each object of a plurality of objects, the method comprising:
graphically positioning a variable data object relative to a graphical asset object;
generating a print file, the print file comprising a plurality of images that are all part of a single print job, wherein each image in the print file comprises the graphical asset object, wherein each image in the print file comprises variable data, wherein the variable data is located relative to the graphical asset object based on the positioning step, wherein the variable data makes each image in the print file different from the rest of the images of the print file, wherein the variable data is object-dependent information comprising on of: package-dependent information, product-dependent information or content-dependent information;
printing each image from the print file on a corresponding object, on a corresponding package for the object, or on a corresponding label for the object, and wherein each image is uniquely associated with only the corresponding object, forming a one-to-one correlation between each object and each image.
